(19) United States
(12) Patent Application Publication
(10) Pub. No.: US 2018/0153159 A1
(43) Pub. Date: Jun. 7, 2018

(54) FATTY NITRILE SOLVENTS FOR AGRICULTURAL FORMULATIONS

(71) Applicant: Akzo Nobel Chemicals International B.V., Arnhem (NL)

(72) Inventors: Shawn ZHU, Stormville, NY (US); Jinxia Susan SUN, Hopewell Junction, NY (US); Logan DEMPSEY, Princeton, NJ (US); Elliot Isaac BAND, Pleasantville, NY (US); Lei ZHANG, Chappaqua, NY (US); Peter WESTBYE, Stenungsund (SE); Michael WALTERS, Rhinebeck, NY (US)

(21) Appl. No.: 15/575,610

(22) PCT Filed: May 19, 2016
(86) PCT No.: PCT/EP2016/061188

§ 371 Date: Nov. 20, 2017

Related U.S. Application Data
(60) Provisional application No. 62/165,334, filed on May 22, 2015.

(30) Foreign Application Priority Data
Jun. 10, 2015 (EP) 15171320.3

(51) Int. Cl. A01N 25/02; A01N 39/04; A01N 25/30

(52) U.S. Cl. CPC A01N 25/02; A01N 25/30; A01N 39/04

(57) ABSTRACT

Use of fatty nitriles as solvents in agrochemical formulations is disclosed. The fatty nitrile used as the solvent in some of the embodiments disclosed herein has the general structure R—C≡N, where the R group is selected from substituted or unsubstituted, linear or branched, alkyl or alkenyl groups having 7-21 carbon atoms. The agrochemical in the formulations described herein can be any chemical useful in agricultural formulations, including pesticides, emulsifiers, and surfactants.

### FIELD OF THE INVENTION

This disclosure relates to the use of fatty nitriles as solvents in agricultural formulations, and more specifically to formulations comprising an agrochemical and a fatty nitrile as solvent.

### BACKGROUND OF THE INVENTION

Solvents are necessary components in many agricultural formulations when there is a difficult to dissolve solid or a very viscous liquid involved. An example of a solvent dissolving a solid agrochemical (pesticide) can be seen in EP2033520A1, where biocides for wood preservation are dissolved in alkyl dimethyl amide solvents to form biocide formulations. An example of a solvent diluting a viscous liquid agrochemical is Witconate® P-1220EH, a common anionic emulsifier containing calcium dodecylbenzene sulfonate (DDBS) (a very viscous liquid) and solvent 2-ethylhexyl alcohol. An example of using a solvent to dilute a liquid pesticide is a 2,4-D ester formulation containing 2,4-D ester, aromatic solvent, and emulsifiers.

Almost all solvents used in agricultural formulations come from petroleum. As such, many solvents are flammable, and many have significant odor associated with them. Some solvents have toxicity issues such as reprotoxicity. Hence the use of such siolvents if often undesired.

Acetonitrile has been used as a solvent in processes to obtain wettable powder, as disclosed for example in U.S. Pat. No. 5,264,213. Acetonitrile used as a solvent for a neem seed extract containing azadirachtin pesticide was also disclosed in U.S. Pat. No. 5,124,349. However, acetonitrile is a highly flammable substance with a flash point of about 2° C. and its use in modern agricultural formulations is not desirable.

US Patent Application No. 2012/208700 discloses a pesticide formulation comprising a solvent, a least one of dibenzylidene sorbitol and analogies of dibenzylidene sorbitol, and an active ingredient. Butyronitrile can be used together with the solvent. The formulations disclosed in US 2012/208700 are thickened by the dibenzylidene sorbitol or analogies of dibenzylidene sorbitol so as to suspend solid actives in the formulations. In US2012/208700, the purpose of the solvent is not to dissolve the actives, but rather to suspend them. Furthermore, butyronitrile is a highly flammable substance with a flash point of 18° C. and its use in modern agricultural formulation is not desirable.

U.S. Pat. No. 4,234,509 discloses the simultaneous production of glycerol and aliphatic nitriles. U.S. Pat. No. 2,589,232 discloses a method of preparing fatty acid nitriles. U.S. Pat. No. 2,135,327 discloses motor fuel containing nitriles. US Patent Application No. 2008/0032913 discloses fragrancing mineral oils such as motor fuels. U.S. Pat. No. 3,234,006 discloses treating hygroscopic particles to prevent caking during storage. U.S. Pat. No. 3,290,139 discloses a process for forming slow release fertilizer comprising urea.

There is a need for a solvent that is derived from renewable raw material and has reduced toxicity.

### SUMMARY OF THE INVENTION

It has now surprisingly been found that fatty nitriles can be used as sustainable and renewable solvents in agricultural formulations to effectively dissolve agrochemicals with at least as good or better results as many conventional solvents used in agricultural formulations.

The present disclosure relates to an agricultural formulation comprising at least one agrochemical and at least one fatty nitrile as solvent. The fatty nitrile has the following general structure:

R—C≡N

where the hydrocarbon group, R—C, is derived from plant or animal sources, where the R group is substituted or unsubstituted, linear or branched, C7 to C21 alkyl or alkenyl groups. In some embodiments, the R group has one or more pendant hydroxyl groups.

In some embodiments, the fatty nitrile is fractionated or stripped. The fatty nitrile can be derived from soybean oil, tallow, canola, rape seed or other natural sources. In one preferred embodiment, the fatty nitrile is oleic nitrile. The fatty nitrile can be present in the formulation in a range of about 5 percent to 70 percent by weight, preferably at 10 to 50 percent, and more preferably at 20 to 40 percent by weight (% w/w).

In other embodiments, the agrochemical is a pesticide, including, for example, herbicides, fungicides, insecticides, and growth regulators. For compositions containing pesticides, the formulation may be an emulsifiable concentrate. In a preferred embodiment, the agrochemical is an aryloxyphenoxypropionic herbicide, a cyclohexene oxime herbicide, or a mixture thereof.

The agrochemical may also be a surfactant, including nonionic surfactants such as castor oil ethoxylate, polyoxyalkylene glycol butyl ether and so forth. The agrochemical may also be a salt of alkyl benzene sulfonate, where the salt can be calcium, dimethylamidopropylamine, isopropylamine, ethylene diamine, monoethanolamine, diethanolamine, triethanolamine, aminoethylethanolamine, diethylenetriamine and mixtures thereof. The agrochemical may also be alkoxylated alkylamines or alkoxylated alkylamine quaternary surfactants.

In a further aspect, the disclosure relates to a method of dissolving agrochemicals by combining a fatty nitrile with an agrochemical in a suitable mixing vessel with agitation.

### BRIEF DESCRIPTION OF THE DRAWINGS

FIG. 1 shows the percent control of Barnyardgrass treated with commercial cyhalofop butyl herbicide formulations (Clincher®) compared to cyhalofop butyl herbicide formulations of the current disclosure over a range of application rates.

FIG. 2 shows the percent control of Broadleaf Singlegrass treated with commercial cyhalofop butyl herbicide formulations (Clincher®) compared to cyhalofop butyl herbicide formulations of the current disclosure over a range of application rates.

FIG. 3 shows the percent control of Johnsongrass treated with commercial cyhalofop butyl herbicide formulations (Clincher®) compared to cyhalofop butyl herbicide formulations of the current disclosure over a range of application rates.

### DETAILED DESCRIPTION OF THE INVENTION

The present disclosure relates to an agricultural formulation comprising at least one agrochemical and at least one fatty nitrile as solvent. The agrochemical can be any chemical useful in agricultural formulations including, for example, pesticides, and surfactants, in particular, emulsifiers.

The fatty nitrile has the general structure of formula (I):

R—C≡N (I)

The R group comprises substituted or unsubstituted, linear or branched C7 to C21 alkyl or alkenyl groups derived from plant or animal sources.

As discussed herein, alkyl groups are saturated hydrocarbon chains containing only carbon and hydrogen atoms. Non-limiting examples of alkyl groups are lauric, myristic, palmitic, stearic, and behenic groups. As discussed herein, the alkenyl groups are unsaturated (containing double bonds) hydrocarbons such as oleic, linoleic, erucic, palmitoleic and the like. In some embodiments, the R group has one or more pendant hydroxyl groups.

In some embodiments of this invention, R is from about C7 to about C21. In some preferred embodiments, R is C17-C21 and the fatty nitrile has undergone a stripping process to improve the odor. Stripping is usually done to remove undesirable volatile materials from a liquid by means of a vapor stream such as steam or nitrogen. In some cases, the stripping process is conducted under vacuum. In some embodiments, the fatty nitrile is fractionated. Fractionation is distillation where a fraction of the liquid is removed at a specific temperature or temperature range and collected. Fractionation is generally done to separate a liquid mixture into individual components.

R—C groups of the disclosure can be derived, for example, from natural sources. Preferred natural sources are oils and fats, such as oils and fats from land animals, marine animals, and plants. Sources of fat and oils from land animals include butterfat, depot fat, lard oil, neat's foot oil, and tallow (such as from beef or mutton), and mixtures thereof. Sources of fat and oils from marine animals include cod-liver oil, herring oil, menhaden oil, sardine oil, sperm oil, and whale oil, and mixtures thereof. Sources of fats and oils from plants include babassu oil, castor oil, canola oil, cocoa butter, coconut oil, corn oil, cotton seed oil, linseed oil, mustard oil, neem oil, niger-seed oil, oiticica oil, olive oil, palm oil, palm-kernel oil, peanut oil, perilla oil, poppy-seed oil,

rapeseed oil, safflower oil, sesame oil, soybean oil, sunflower-seed oil, tall oil, tung oil, wheat germ oil and mixtures thereof.

Further the R group can possess one or more pendant hydroxyl groups. Examples of a fatty nitrile with one or more pendant hydroxyl groups include the fatty nitriles derived from castor oil and epoxydized soybean oil.

When the agrochemical is a pesticide, the pesticide can be a fungicide, an insecticide, a growth regulator, an herbicide or a mixture thereof.

Non-limiting examples of fungicides include, but are not limited to: Acibenzolar-S-methyl, aldimorph, amisulbrom, anilazine, azaconazole, azoxystrobin, benalaxyl, benodanil, benomyl, benthiavalicarb, binapacryl, biphenyl, bitertanol, blasticidin-S, boscalid, bromuconazole, bupirimate, captafol, captan, carbendazim, carboxin, carpropamid, chloroneb, chlorothalonil, chlozolinate, copper, cyazofamid, cyflufenamid, cymoxanil, cyproconazole, cyprodinil, dichlofluanid, diclocymet, diclomezine, dicloran, diethofencarb, difenoconazole, diflumetorim, dimethirimol, dimethomorph, dimoxystrobin, diniconazole, dinocap, dithianon, dodemorph, dodine, edifenphos, enestrobin, epoxiconazole, etaconazole, ethaboxam, ethirimol, etridiazole, famoxadone, fenamidone, fenarimol, fenbuconazole, fenfuram, fenhexamid, fenoxanil, fenpiclonil, fenpropidin, fenpropimorph, fentin acetate, fentin chloride, fentin hydroxide, ferbam, ferimzone, fluazinam, fludioxonil, flumorph, fluopicolide, fluoxastrobin, fluquinconazole, flusilazole, flusulfamide, flutolanil, flutriafol, folpet, fosetyl-Al, fthalide, fuberidazole, furalaxyl, furametpyr, guazatine, hexaconazole, hymexazole, imazalil, imibenconazole, iminoctadine, iodocarb, ipconazole, iprobenfos (IBP), iprodione, iprovalicarb, isoprothiolane, isotianil, kasugamycin, kresoxim-methyl, laminarin, mancozeb, mandipropamid, maneb, material of biological, mepanipyrim, mepronil, meptyldinocap, metalaxyl, metalaxyl-M, metconazole, methasulfocarb, metiram, metominostrobin, metrafenone, mineral oils, organic oils, myclobutanil, naftifine, nuarimol, octhilinone, ofurace, origin, orysastrobin, oxadixyl, oxolinic acid, oxpoconazole, oxycarboxin, oxytetracycline, pefurazoate, penconazole, pencycuron, penthiopyrad, phophorous acid and, picoxystrobin, piperalin, polyoxin, potassium bicarbonate, probenazole, prochloraz, procymidone, propamocarb, propiconazole, propineb, proquinazid, prothiocarb, prothioconazole, pyraclostrobin, pyrazophos, pyribencarb, pyributicarb, pyrifenox, pyrimethanil, pyroquilon, quinoxyfen, quintozene (PCN B), salts, silthiofam, simeconazole, spiroxamine, streptomycin, sulphur, tebuconazole, teclofthalam, tecnazene (TCNB), terbinafine, tetraconazole, thiabendazole, thifluzamide, thiophanate, thiophanate-methyl, thiram, tiadinil, tolclofosmethyl, tolylfluanid, triadimefon, triadimenol, triazoxide, tricyclazole, tridemorph, trifloxystrobin, triflumizole, triforine, triticonazole, validamycin, valiphenal, vinclozolin, zineb, ziram, and zoxamide.

Non-limiting examples of insecticides are organophosphate insecticides including acephate (CAS RN 30560-19-1), chlorpyrifos, chlorpyrifos-methyl (CAS RN 5598-13-0), neonicotinoid insecticide, pyrethrin, pyrethroids, and methoprene. Additional insecticide examples include imidacloprid, thiamethoxam, clothianidin, dinotefuran, flonicamid, nithiazine, or thiacloprid, an oxidiazine insecticide, such as 5-(2-chloropyrid-5-ylmethyl)-3-methyl-4-nitroiminoperhydro-1,3,5-oxadiazine, 5-(2-chlorothiazol-5-ylmethyl)-3-methyl-4-nitroiminoperhydro-1,3,5-oxadiazine, 3-methyl-4-nitroimino-5-(1-oxido-3-pyridinomethyl)perhydro-1,3,5-oxadiazine, 5-(2-chloro-1-oxido-5-pyridiniomethyl)-3-methyl-4-nitroiminoperhydro-1,3,5-oxidiazine; or 3-methyl-5-(2-methylpyrid-5-ylmethyl)-4-nitroiminoperhydro-1,3,5-oxadiazine; a carbamate insecticide such as aldicarb (CAS RN 116-06-3); carbaryl (CAS RN 63-25-2); carbofuran (CAS RN 1563-66-2); oxamyl (CAS RN 23135-22-0; or thiodicarb (CAS RN 59669-26-0).

Non-limiting examples of a plant growth regulators include MH (maleic hydrazide), Ethrel (2-chloroethylphosphonic acid), UASTA and Bialophos.

Non-limiting examples of herbicides include amide herbicides, anilide herbicides, arylalanine herbicides, chloroacetanilide herbicides, sulfonanilide herbicides, sulfonamide herbicides, thioamide herbicides, benzoic acid herbicides, pyrimidinyloxybenzoic acid herbicides, pyrimidinylthiobenzoic acid herbicides, phthalic acid herbicides, picolinic acid herbicides, quinolinecarboxylic acid herbicides, arsenical herbicides, benzoylcyclohexanedione herbicides, benzofuranyl alkylsulfonate herbicides, benzothiazole herbicides, carbamate herbicides, carbanilate herbicides, carbonate herbicides, cyclohexene oxime herbicides, cyclopropylisoxazole herbicides, dicarboximide herbicides, dinitroaniline herbicides, dinitrophenol herbicides, diphenyl ether herbicides, nitrophenyl ether herbicides, dithiocarbamate herbicides, fumigant herbicides, halogenated aliphatic herbicides, imidazolinone herbicides, nitrile herbicides, organophosphorus herbicides, oxadiazolone herbicides, oxazole herbicides, phenoxy herbicides, phenoxyacetic herbicides, phenoxybutyric herbicides, phenoxypropionic herbicides, aryloxyphenoxypropionic herbicides, phenylenediamine herbicides, pyrazole herbicides, benzoylpyrazole herbicides, phenylpyrazole herbicides, pyridazine herbicides, pyridazinone herbicides, pyridine herbicides, pyrimidinediamine herbicides, pyrimidinyloxybenzylamine herbicides, thiocarbamate herbicides, thiocarbonate herbicides, thiourea herbicides, triazine herbicides, triazinone herbicides, triazole herbicides, triazolone herbicides, triazolopyrimidine herbicides, uracil herbicides, urea herbicides, phenylurea herbicides, sulfonylurea herbicides, and thiadiazolylurea herbicides. Preferred examples include dicamba and its derivatives, acetochlor, butachlor, alachlor, metolachlor, 2,4-D and its derivatives, MCP (2-methyl-4-chlorophenoxyacetic acid), MCPP d,1-2-(4-chloro-o-tolyloxy) propionic acid and its derivatives, and Triclopyr (3,5,6-trichloro-2-pyridyloxyacetic acid and its derivatives), cyhalofop butyl. In some embodiments of this invention the herbicide is 2,4-D ester, MCPA ester, dicamba ester, cyhalofop-butyl, propanil, and acetochlor. More preferred herbicides include aryl-propanoic acids (“fops”) and cyclohexanedione (“dims”) herbicides. They are acetyl-CoA carboxylase (ACCase) inhibitors. They have predominantly, or exclusively, graminicidal action and are widely used for control of many annual and perennial grass weeds. An example of a commercial brand using a “fop” is Clincher® (Dow AgroSciences LLC) where the herbicide active is cyhalofop belonging to the aryloxyphenoxypropionic herbicide family. An example of a commercial brand using a “dim” is Arrow® 2 EC (MANA) where the herbicide is clethodim belonging to the cyclohexene oxime family.

Oil-based adjuvants such as a crop oil concentrate (COC) improve the efficacy of “dims” herbicides better than surfactant-based adjuvants. For example, Arrow® 2 EC includes label requirements of a COC “at 1 qt/A by ground or 1% v/v, but not less than 1 pt/A.” However, the difference between oil-based adjuvants and surfactant-based adjuvants in enhancement of “fops” activity is not significant. For example, the label recommendation for Fusilade DX (containing fluazifop, another aryloxyphenoxypropionic herbicide) is to “either mix with crop/vegetable oil concentrate or nonionic surfactants.” However, when Fusilade is combined with some herbicides, a crop oil concentrate is required rather than surfactant-based adjuvants. Many of the ACCase inhibitors are formulated as emulsifiable concentrates.

As used herein, the term “pesticide” means a compound having biological activity that kills or retards the growth of pests that interfere with the growth of plants. For avoidance of doubt, the term “pesticide” does not encompass substances such as water or oil or devices such as fly swatters that kill pests by drowning or other non-biologically active mechanisms.

Many commercially available agricultural formulations contain hydrocarbons and aromatic compounds such as naphthalene, toluene, xylene, 2-ethylhexyl alcohol, isopropyl alcohol, ethanol, methanol, aromatic solvents, and the like. One such example is the formulation Clincher® (Dow AgroSciences LLC) which contains ethyltoluene, 1,2,4-trimethyl benzene, cumene, xylene and polygylcol at 70% of the total commercial concentrate. These compounds are acceptable solvents for many pesticides and have been widely used for years. But the origin, toxicity, flammability and concerns surrounding these compounds is problematic. The nitriles described herein are derived from biobased resources and tend to be non-volatile.

Some agricultural formulations described herein contain a mixture of a surfactant blend and a nitrile, and provide better control than the best commercially available product on the market. Preferred surfactants for these systems will be either non-ionic or cationic surfactants. Cationic surfactants can contain a tertiary or quaternary nitrogen in which at least one of the groups attached to the nitrogen is a long chain alkyl group. In some embodiments of this disclosure, the surfactant will be a mixture of cationic and non-ionic surfactants.

In some formulations the surfactant can be, for example, an alkyl benzene sulfonate, or a salt of dodecylbenzene sulfonate (DDBS). Examples of some salts of DDBS useful in the present disclosure are calcium, dimethylamidopropylamine (DMAPA), isopropylamine, ethylene diamine, monoethanolamine, diethanolamine, triethanolamine, aminoethylethanolamine, diethylenetriamine, or mixtures thereof. In some embodiments of this disclosure, the salt of DDBS is calcium.

The nitriles detailed in this invention provide not only a solvent but also a liquid medium for the agrochemicals including active ingredients. A nitrile may be a good solvent for one agrochemical, capable of dissolving a substantial amount of that agrochemical, but it may be a poor solvent for another agrichemical. When the nitrile is a poor solvent for an agrochemical, it may be used in some cases as liquid medium to disperse or suspend the agrochemical.

The concentration of the alkyl nitrile in the agricultural formulations of the present disclosure can be from about 1 to about 99 percent of the total formulation weight, more particularly from about 5 to about 98 percent of the total formulation weight. In some embodiments of this disclosure, the nitrile will be present in the formulation from about 5 to about 70 percent. In other embodiments, the nitrile will be present in the formulation from about 10 to about 50 percent. In still other embodiments, the nitrile will be present in the formulation from about 20 to about 40 percent of the total formulation weight.

It should be appreciated that features from any aspects and embodiments of the invention may be combined with features from all other aspects and embodiments of the invention. It is furthermore noted that in an embodiment the agrochemical itself is not a fatty nitrile of formula (I). The Examples are intended to exemplify the present invention, but are not intended to limit the scope of the invention in any way. The breadth and scope of the invention are to be limited solely by the claims appended hereto.

Various embodiments of the present disclosure will now be illustrated by the following Examples. Unless otherwise noted, all processes refer to and all examples were performed under conditions of standard temperature and pressure (STP). All ranges cited herein are inclusive and combinable. Herein, unless otherwise noted, all percent compositions are provided on a weight/weight basis.

### Example 1

Table 1 shows the solubility of various pesticides in alkyl nitrile. In Table 1, the designation of C14-18 represents the nitrile derived from tallow and C8-C16 represents the nitrile derived from coco. Note that the C14-C18 tallow nitrile corresponds to an R value of C13-C17 in Formula (I), because Formula (I) includes a carbon atom outside of the R group definition. Likewise, C8-C16 coco nitrile corresponds to an R value of C7-C15 in Formula (I). The C10 value in the first column of Table 1 corresponds to an R value of C9 in Formula (I) for the same reasons.

TABLE 1
Solubility of various pesticides in alkyl nitrile

| Alkyl | | | | | | |
|---|---|---|---|---|---|---|
| Nitrile | Wt, g | Ingredient 1 | Wt, g | Ingredient 2 | Wt, g | Result |
| C14-C18 | 1.97 | Bifentherin | 0.06 | | | Clear and viscous at |
| | | | | | | room temperature |
| | | | | | | and at 0° C. |
| C14-C18 | 100 | Chlorpyrifos | 44 | | | Dissolved |
| C14-C18 | 100 | Propanil | 16 | | | Dissolved |
| C14-C18 | 100 | Tebuconazole | <10 | | | Dissolved |
| C14-C18 | 100 | Trifloxystrobin | <10 | | | Dissolved |
| C14-C18 | 5 | Glyphosate | 0.1 | | | Solid at bottom |
| | | acid | | | | |
| C10 | 40 | Methyl ester | 60 | Chlorpyrifos | 166 | Dissolved at room |
| | | solvent | | | | temperature |
| C10 | 30 | Methyl ester | 70 | Chlorpyrifos | 100 | Dissolved at room |
| | | solvent | | | | temperature |
| C10 | 20 | Methyl ester | 80 | Chlorpyrifos | 87 | Dissolved at room |
| | | solvent | | | | temperature |
| C14-C18 | 1 | Nicosulfuron | 0.114 | | | Suspension |
| | | (92.22%) | | | | |
| C14-C18 | 5 | Pyritherin | 3.15 | | | Clear |
| C10 | 50 | Rapeseed | 50 | Trifloxystrobin | 14 | Dissolved at room |
| | | methylester | | | | temperature |
| | | (solvent) | | | | |
| C14-C18 | 5 | Tebuconazone | 0.4 | | | Hazy to clr |
| C14-C18 | 1 | Urea | 0.26 | | | Doesn't dissolve |
| C8-C16 | 0.5 | 2,4-D acid | 5.5 | Soy amine - | 4.5 | Clear and viscous at |
| | | | | 2EO | | room temp. Gel at 0° |
| | | | | (surfactant) | | C. |
| C8-C16 | 0.5 | 2,4-D acid | 5.5 | Soy amine- | 5 | Clear and viscous at |
| | | | | 2EO:Isopropyl | | room temperature |
| | | | | alcohol (4.5:0.5) | | and at 0° C. |
| C14-C18 | 5 | 2,4-D DMA | 0.1 | | | Solid at bottom |
| C14-C18 | 5.01 | Acetochlor | 5.61 | | | Clear. Mutually |
| | | (liquid | | | | soluble. |
| | | herbicide) | | | | |
| C10 | 100 | Chlorpyrifos | 84 | | | Dissolved at room |
| | | | | | | temperature |
| C10 | 100 | Propanil | 41 | | | Dissolved at room |
| | | | | | | temperature |
| C10 | 100 | Tebuconazole | <10 | | | Dissolved at room |
| | | | | | | temperature |
| C10 | 100 | Trifloxystrobin | 19 | | | Dissolved at room |
| | | | | | | temperature |
| C10 | 20 | Solvesso 100 | 80 | Chlorpyrifos | 102 | Dissolved at room |
| | | solvent | | | | temperature |
| C10 | 35 | Solvesso 100 | 65 | Chlorpyrifos | 103 | Dissolved at room |
| | | solvent | | | | temperature |
| C10 | 50 | Solvesso 100 | 50 | Chlorpyrifos | 102 | Dissolved at room |
| | | solvent | | | | temperature |
| C14-C18 | 10 | Atrazine | 0.07 | | | Undissolved crystal |
| | | | | | | at bottom |

The data in Table 1 shows that alkyl nitrile has good solubilizing power toward many chemicals, either as a sole solvent or as a co-solvent. The C10 nitrile (Arneel 10D) can dissolve about 46% chlorpyrifos. Oleic nitrile (C18, R═C17 in Formula I) also has similar solubility power as tallow nitrile.

The data also shows that fatty nitrile has very little solvency power towards certain agrochemicals such as atrazine and urea. In this case, it is possible to use fatty nitrile as a liquid medium to suspend the agrochemicals using appropriate thickeners and suspension aids.

### Example 2

Two emulsifiable concentrates (EC) of cyhalofop-butyl, a solid herbicide, were prepared as shown in Table 2 below.

TABLE 2
Emulsifiable concentrates of Cyhalofop-butyl

| | Sample 1 | Sample 2 |
|---|---|---|
| Ingredient | (percent) | (percent) |
| Cyhalofop-butyl (96.5%) | 10 | 10 |
| Tallow nitrile | 50 | |
| Oleic nitrile | | 50 |
| Adsee AB-600 (Tallowamine | 7.36 | 7.36 |
| alkoxylate) | | |
| Ethoquad T/24HA (ethoxylated | 8.64 | 8.64 |
| tallow quaternary with 14EO) | | |
| Castor oil ethoxylate (20EO) | 12 | 12 |
| Polyoxyalkylene Glycol Butyl Ether | 12 | |
| Witconate P-1220EH (60% Ca- | | 12 |
| DDBS in 40% 2-EH alcohol) | | |

The two ECs were stable between about 0° and 40° C. The emulsification performance of the ECs were excellent in 34 mg/kg (ppm) water and 1000 mg/kg (ppm) hard water.

### Example 3

Sample 3 (an emulsifiable concentrate formulation, EC) was prepared by mixing the following ingredients:

10% ai Cyhalofop butyl (96.5% active)

50% oleic nitrile

8% tallowamine alkoxylate

8% ethoxylated tallowamine (15EO) methylchloride quaternary

12% castor oil ethoxylate with 20 EO

12% polyoxyalkylene glycol butyl ether

The surfactant blend in the EC formulation is used as both an emulsifier and an activator adjuvant to increase the biological efficacy of cyhalofop butyl.

### Formulation Stability:

The EC formulation itself was very stable at both high and low temperatures. The formulation remained in a single phase following 2 week storage at 50° C. There was no evidence of separation or formation after 3 freeze/thaw overnight storage cycles between −20° C. and room temperature (20° C.).

### Emulsion Stability:

The EC formulation was diluted in water at a rate of 5% (5 ml formulation in 95 ml of water) in a 100 ml cylinder and inverted 10 times. The emulsion stability tests were performed in water of 34, 342 and 1000 mg/kg (ppm) hardness, whereby 1 ppm represents 1 mg of CaCO₃ per kg of water. Only a very small amount of cream was observed at the top of the emulsions after overnight standing. This small amount of cream was easily redispersed into a homogeneous emulsion again following 10 inversions.

### Greenhouse Testing of Biological Efficacy:

Greenhouse trials were performed on three different grasses at three different application rates. Bioefficacy performance was examined by looking at the percent control up to 4 weeks after treatment. Percent control was determined by comparing the amount of grass remaining in a treated pot with the same grass in an untreated pot. The three types of grass were examined in this example and they were Barnyardgrass, Broadleaf Singlegrass and Johnson grass. The three species have different degrees of susceptibility to “fops” herbicides. The three application rates tested were 12.0, 23.9, and 45.9 ml/hectare (1, 2, and 4 fl oz/acre, respectively). The detailed data from the greenhouse trails are presented below.

TABLE 3
Percent Control of Barnyardgrass Treated with Cyhalofop
Formulations Barn yardgrass

| | | Weeks after Treatment | | | |
|---|---|---|---|---|---|
| | | 1 | 2 | 3 | 4 |
| | | % Control | | | |
| Clincher ® | (12.0 ml/hectare) | 65 | 55 | 35 | 15 |
| Sample 3 | (12.0 ml/hectare) | 74 | 63 | 45 | 40 |
| Clincher ® | (23.9 ml/hectare) | 75 | 74 | 64 | 56 |
| Sample 3 | (23.9 ml/hectare) | 84 | 89 | 90 | 89 |
| Clincher ® | (47.9 ml/hectare) | 75 | 89 | 93 | 95 |
| Sample 3 | (47.9 ml/hectare) | 79 | 85 | 91 | 92 |

The concentration of cyhalofop butyl was the same in the Sample 3 EC formulation as in the commercial Clincher® formulation. The greenhouse results show that, compared to Clincher®, the EC formulation exhibited as good (at 47.9 ml/hectare rate) or superior (at 12.0 and 23.9 ml/hectare rates) biological efficacy performance. FIG. 1 illustrates the percent control of Barnyardgrass treated with commercial cyhalofop butyl herbicide formulations) (Clincher®) compared to cyhalofop butyl herbicide formulations of the current disclosure over a range of application rates.

TABLE 4
Percent Control of Broadlead Singlegrass Treated with
Cyhalofop Formulations Broadleaf Singlegrass

| | | Weeks after treatment | | | |
|---|---|---|---|---|---|
| | | 1 | 2 | 3 | 4 |
| | | % Control | | | |
| Clincher ® | ( 12.0 ml/hectare) | 89 | 69 | 29 | 15 |
| Sample 3 | ( 12.0 ml/hectare) | 94 | 66 | 50 | 25 |
| Clincher ® | (23.9 ml/hectare) | 94 | 88 | 66 | 69 |
| Sample 3 | (23.9 ml/hectare) | 95 | 94 | 98 | 94 |
| Clincher ® | (47.9 ml/hectare) | 96 | 98 | 96 | 96 |
| Sample 3 | (47.9 ml/hectare) | 98 | 98 | 99 | 99 |

The greenhouse results show that, compared to Clincher®, the EC formulation has as good (at 47.9 ml/hectare rate) or superior (at 12.0 and 23.9 ml/hectare rates) biological efficacy performance. The % control of the Sample 3 formulation at 23.9 ml/hectare was similar to the % control of Clincher® at 47.9 ml/hectare. FIG. 2 illustrates the percent control of Broadleaf Singlegrass treated with commercial cyhalofop butyl herbicide formulations (Clincher®) compared to cyhalofop butyl herbicide formulations of the current disclosure over a range of application rates.

TABLE 5
Percent Control of Johnson Grass Treated with Cyhalofop
Formulations Johnson grass

| | | Weeks after treatment | | | |
|---|---|---|---|---|---|
| | | 1 | 2 | 3 | 4 |
| | | % Control | | | |
| Clincher ® | (12.0 ml/hectare) | 79 | 48 | 23 | 13 |
| Sample 3 | (12.0 ml/hectare) | 76 | 65 | 28 | 28 |
| Clincher ® | (23.9 ml/hectare) | 80 | 60 | 45 | 28 |
| Sample 3 | (23.9 ml/hectare) | 84 | 73 | 55 | 50 |
| Clincher ® | (47.9 ml/hectare) | 80 | 75 | 63 | 40 |
| Sample 3 | (47.9 ml/hectare) | 85 | 88 | 80 | 69 |

The greenhouse results show that, compared to Clincher®, Sample 3 had superior biological efficacy performance at all three rates. FIG. 3 illustrates the percent control of Johnson grass treated with commercial cyhalofop butyl herbicide formulations (Clincher®) compared to cyhalofop butyl herbicide formulations of the current disclosure over a range of application rates.

### Example 4

Dimethylaminopropylamine dodecylbenzene sulfonic acid (DMAPA-DDBS) is generally highly viscous. A low viscosity liquid sample of (DMAPA) DDBS was obtained by mixing 51.69 g of DDBS, 40 g tallow nitrile (fractionated), followed by slowly adding 8.31 g DMAPA. This sample was clear, flowed freely at room temperature and had acceptable viscosity.

Another sample was made using oleic nitrile instead of tallow nitrile and the sample has similar properties as the (DMAPA) DDBS tallow-nitrile sample, except the oleic nitrile sample flowed better at lower temperatures. Hence, oleic nitrile may be more suitable for use as a solvent at lower temperatures.

### Example 5

A liquid sample of dimethylaminopropylamine (DMAPA) DDBS was obtained by mixing 43.08 g dodecylbenzene sulfonic (DDBS) acid, 25 g oleic nitrile, 25 g castor oil ethoxylate (10EO), followed by slowly adding 6.92 g DMAPA. This sample was clear, flowed at about 0° C., and had acceptable viscosity.

### Example 6

A liquid sample of dimethylaminopropylamine (DMAPA) DDBS was obtained by mixing 43.08 g dodecylbenzene sulfonic (DDBS) acid, 25 g oleic nitrile, 25 g castor oil ethoxylate (10EO), followed by slowly adding 6.92 g DMAPA. This sample was clear, flowed at about 0° C., and had acceptable viscosity.

Other nonionic liquid surfactants can be used in the formulations disclosed herein, similar to the formulation as shown in example 6.

In another aspect of the present invention, a method of dissolving agrochemicals is provided. The method comprises combining a fatty nitrile of the type disclosed herein with an agrochemical in a suitable mixing vessel with agitation.

All documents cited in the Detailed Description of the Invention are, in relevant part, incorporated herein by reference; the citation of any document is not to be construed as an admission that it is prior art with respect to the present invention.

1. A liquid agricultural formulation comprising at least one agrochemical selected from the group consisting of aryloxyphenoxypropionic herbicides, cyclohexene oxime herbicides and mixtures thereof, and at least one fatty nitrile, wherein the fatty nitrile has the following general structure (I):
R—C≡N (I)
wherein the R group is selected from a substituted or unsubstituted, linear or branched, alkyl or alkenyl groups having 7-21 carbon atoms, and wherein the liquid agricultural formulation has a fatty nitrile concentration of about 5 to about 98 percent by weight.

2. The liquid agricultural formulation of claim 1 wherein the R group is derived from plant or animal sources.

3. The liquid agricultural formulation of claim 1 wherein the fatty nitrile is derived from an oil selected from the group consisting of coconut oil, palm oil, soybean oil, corn oil, sun flower oil, rape seed oil, canola oil, castor oil, tallow, lard, fish oil and mixtures thereof.

4. The liquid agricultural formulation of claim 1 wherein the R group has one or more pendant hydroxyl groups.

5. The liquid agricultural formulation of claim 1 wherein the fatty nitrile is present in the composition in a range of 5 percent to 70 percent by weight.

6. The liquid agricultural formulation of claim 1 wherein the agrochemical is a salt of alkyl benzene sulfonate.

7. The liquid agricultural formulation of claim 1 wherein the formulation is an emulsifiable concentrate comprising at least one pesticide.

8. The liquid agricultural formulation of claim 1 further comprising a nonionic surfactant.

9. The liquid agricultural formulation of claim 1 wherein the fatty nitrile is oleic nitrile.

10. The liquid agricultural formulation of claim 1 wherein the pesticide is an herbicide.

11. The liquid agricultural formulation of claim 1 further comprising at least one adjuvant compound.

12. The liquid agricultural formulation of claim 11 wherein the adjuvant compound is selected from the group consisting of alkoxylated alkylamines, quaternary alkoxylated alkylamine surfactants, and mixtures thereof.

13. A method of suspending agrochemicals comprising combining at least one fatty nitrile with at least one agrochemical selected from the group consisting of aryloxyphenoxypropionic herbicides, cyclohexene oxime herbicides and mixtures thereof, in a suitable vessel and mixing the contents of the vessel, wherein the fatty nitrile has the following general structure (I):
R—C≡N (I)
and wherein the R group is selected from a substituted or unsubstituted, linear or branched, alkyl or alkenyl groups having 7-21 carbon atoms.
